(19) United States
(12) Patent Application Publication
(10) Pub. No.: US 2013/0062900 A1
(43) Pub. Date: Mar. 14, 2013

(54) Hard sided pop-up truck camper

(71) Applicant: Michael James Bullard, Cedar Rapids, IA (US)

(72) Inventor: Michael James Bullard, Cedar Rapids, IA (US)

(21) Appl. No.: 13/199,938

(22) Filed: Sep. 14, 2011

(51) Int. Cl. B60P 3/34

(52) U.S. Cl. 296/26.04

(57) ABSTRACT

This invention is a hard sided pop-up truck camper that fits on an ordinary pickup truck. When folded down, it looks like a typical pickup truck topper and will allow the truck to fit into a garage. The folding sides take up less than 6 inches of height when folded which maximizes its use as a topper for hauling while also maximizing the vertical height when erected so it can be used as a camper. When erected, it allows a person to stand upright throughout the inside of the camper. Current hard sided pop-up truck campers are designed to extend by raising straight up mechanically, the sides do not fold down upon themselves like this invention does. Also, current hard sided pop-up truck campers in the down position typically extend above the cab of the truck making them too high to fit through a garage door.

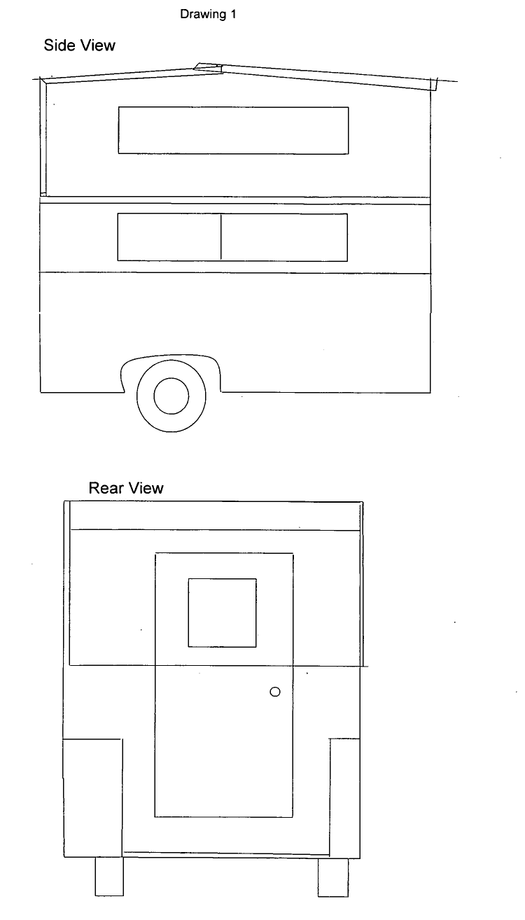

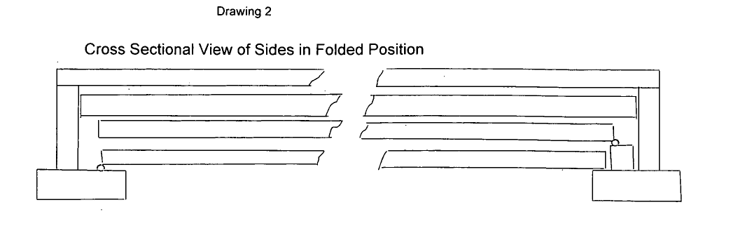

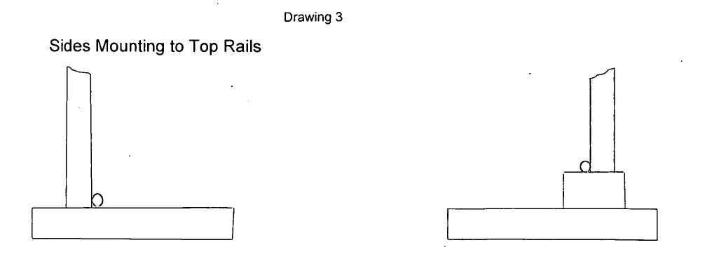

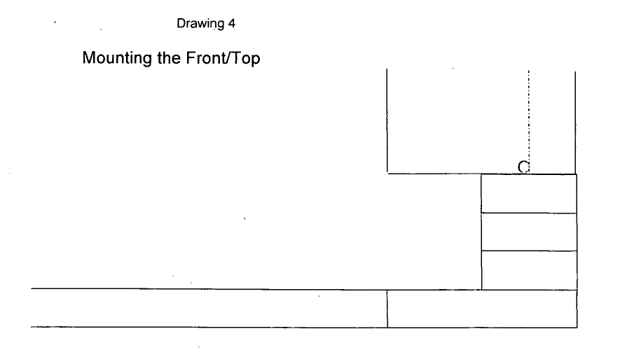

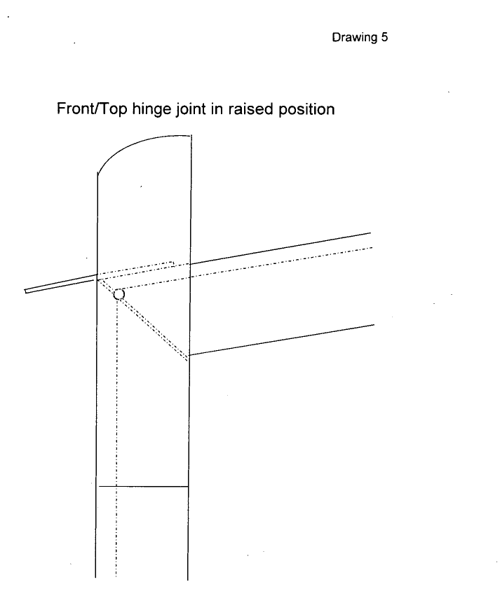

### FIELD OF THE INVENTION

The present invention relates to the design of a hard sided pop-up pickup truck camper so that it can be used as a topper when folded down and a camper when erected. This invention has sides that fold down upon themselves to a compact size of about 6 inches in height. The folded sides rest on top of a fixed side wall so that the total height when folded down is about the same height as a typical pickup truck topper. Specifically, the invention relates to the design of a pickup truck camper that is the same size as a pickup truck topper. This invention combines the benefits of a topper, low height and sheltered hauling space with the benefits of a camper, ability to stand erect within the unit.

### BACKGROUND

Present day pickup truck campers are either large fixed units that do not pop up or smaller fixed units that allow the top cap to rise vertically by means of cranks and cables. The smaller units generally extend above the cab of the pickup truck when in the down position making the unit too tall so the truck can not be parked in a garage with a standard seven foot tall garage door. There are also pickup truck toppers usually made out of fiberglass that do not extend above the cab of the pickup truck. Toppers will allow a truck owner to pull into the standard garage. Toppers do not allow enough room to stand erect however and therefore do not work well as campers. There are also tent campers for pickup trucks but they are not hard sided so do not offer the security and protection that a hard sided unit affords.

So, this invention creates a hard sided pop-up camper with the folded down size of an average topper but the erected size with enough vertical height to allow an adult to stand upright which allows for comfortable camping. See drawing 1 and 2. The method used to fold the sides up and then down on each other is unique to current pickup truck campers.

### SUMMARY OF THE INVENTION

### Overview

This hard sided pop-up truck camper is mounted on the sides of a pickup truck bed. First there is a short wall mounted to the sides of the truck bed. The folding sides are then mounted on the top of the short walls. The folding sides fold down to less than six inches of height which allows the unit to be used for hauling like a topper and also to be low enough in height to pull into a standard garage like a topper. The left and right side walls fold in first, one on top of the other. The top of the first side wall folds down and rests on the opposing short wall. The second side wall to fold down rests on the first side wall. The back wall is folded down next and then the front/top wall folds down last and fully encapsulates the other walls. The front and back walls are hinged in the middle so that they form a vertical wall arising from the short wall then at the hinge; they angle in a horizontal manner to form the roof line. The height of the side walls supports the roof line of both the front and back sides to provide stability to the structure.

An object of the invention is to overcome some of the drawbacks relating to current pickup truck campers as discussed above.

Hence, in a first aspect there is provided a method for folding the camper sides down that makes efficient use of space so that the vertical height of the folded down unit is low enough to allow the pickup truck to be driven into a standard garage. The height of the folded down unit consists of the height of the fixed side walls plus the folded sides. The folding sides are approximately 1.5 inches thick. The front/top side is the last to be folded down and it has 6 inch tall side rails that completely encapsulate the other folded sides. See drawing 2. Additionally, the folded down unit does not extend past the width of the truck bed.

In a second aspect there is enough height when the unit is fully erected to allow an average adult to stand upright within it. This is accomplished be taking advantage of the height of the pickup bed plus the height of the fixed side walls plus the height of the erected walls. See drawing 1. The folding sides are mounted and hinged to the top of the fixed side walls. See drawing 3, 4 and 5. The first side wall to fold down is hinged to the top of the fixed side wall. The second side wall is mounted 1.5 inches above the first side wall so that when it is folded, it lays perfectly flat on top of the first side wall. See drawing 4. Because they are mounted on the fixed side walls, the folding sides can be less than five feet tall which is the standard width of a full size pickup truck bed. The back wall is mounted 3 inches above the first side wall and 1.5 inches above the second side wall so that it also will lay perfectly flat on top of the second side wall. The front/top wall is mounted 4.5 inches above the first side wall, 3 inches above the second side wall and 1.5 inches above the back wall so that it will fold down and lay perfectly flat on top of the back wall. The sides of the front/top wall rest on the top rail of the fixed sides and fully encapsulate the other folded sides. See drawing 5.

In a third aspect, the front and back sides of the unit can be hinged at approximately three feet of vertical rise leaving about five feet of horizontal roof. The five feet of horizontal roof on both the front and back sides allows the roof lines to intersect above the standard eight foot pickup truck bed at such an angle as to provide a moderate slope. See drawing 6. The slopes of the roof panels benefit both rain drainage and the stability of the unit. The slope of the roof panels is also designed into the side walls so that the top of the side walls matches up perfectly with the roof panels along their entire length providing strength and rigidity to the erected unit.

In summary, the uniqueness of this design centers around the manner in which the sides are attached to a short fixed wall and hinged which allows the unit to fold very flat and within the confines of a standard pickup topper yet when erected, the hinges and side design allows the unit to be tall enough for an adult to stand upright with good structural rigidity so that it can function as a camper.

### BRIEF DESCRIPTION OF THE DRAWINGS

Having thus described the invention in general terms, reference will now be made to the accompanying drawings, which are not necessarily drawn to scale, and wherein:

Drawing 1—Shows a side and rear view of the erected hard sided pop-up truck camper according to one embodiment of the present invention.

Drawing 2—Shows a side and rear view of the folded hard sided pop-up truck camper according to one embodiment of the present invention.

Drawing 3—Shows a cross sectional view of the folded down sides to display how they are stacked within and fully encapsulated by the Front/Top side according to one embodiment of the present invention.

Drawing 4—Illustrates how the left and right sides of the invention are mounted to the top of the fixed short wall to enable the folding down illustrated in drawing 2.

Drawing 5—Illustrates how the Front/Top side is mounted to the top of the fixed short wall to enable the folding down illustrated in drawing 2.

Drawing 6—Shows the hinge structure on the Front/Top wall which enables it to transition from vertical to horizontal when erected.

### DETAILED DESCRIPTION OF THE INVENTION

The present invention now will be described more fully hereinafter with reference to the accompanying drawings, in which an example of an embodiment of the invention is shown. Indeed, this invention may be embodied in many different forms and should not be construed as limited to the embodiment set forth herein; rather, this embodiment is provided by way of example so that this disclosure will satisfy applicable legal requirements. Like numbers refer to like elements throughout.

A standard pickup bed is about 19 inches tall and about 5 feet wide. This invention would start by mounting about a 14 inch fixed side wall to the sides of the pickup truck bed so that the height from the floor of the pickup bed to the top of the fixed side walls is about 33 inches tall. There would need to be some windows mounted in the fixed side walls to allow ventilation and viewing. The top rails on top of the fixed walls would be wide enough to allow mounting of the fixed sides. One top rail would need to be wider than the other to allow the apex of the first side to get folded down to rest on the opposing top rail.

On top of the fixed side walls then the folding sides would be mounted. The folding sides when folded down would take up about 6 inches of height. So the height of the unit when folded down from the floor of the pickup bed would be about 39 inches which is the height of a standard topper and also the height to the top of the standard cab.

The left and right sides would be mounted with hinges to the top of the fixed side walls. One side would need to be mounted one wall thickness above the other side so that they would fold flat. See drawing 3 and 4. The thickness of the walls is about one and one half inches. The left and right side walls should be mounted on the top rails leaving enough space so that when folded, the sides of the front/top side can clear all the other sides and rest on the top plate of the fixed side walls.

The length of the left and right sides would be long enough to span the length of the pickup truck bed less an amount necessary to mount the back and front walls. A typical pickup truck bed is 8 feet long so the sides would be about 5 or 6 inches less than that. The length of the left and right side walls allows them to align perfectly with the vertical sides of the back and front sides when in the erect position.

The height of the left and right sides would about 42 and 40.5 inches on their edge sides and then angle to at least 48 and 46.5 inches of height, respectively in the middle of the sheet. The second side to fold down is mounted about 1.5 inches above the first side wall which is the reason for the two different height measurements. The height in the middle of the left and right side sheets being greater than the height on the edges is designed to allow the first sheet to fold down and rest on the top rail of the opposing fixed side. Also, the slope and height of the left and right sides from the edge to the middle is designed to match the roof slopes of the back and front sides from their mid hinge position to the middle apex of the roof. Windows are positioned into the left and right folding sides. Additionally, a rope is attached to the top middle of these sides to help erect the unit.

The back side is also mounted to a fixed wall. This invention embodiment would replace the tail gate with a 36 inch wide door mounted in a fixed wall that extends from the floor of the truck bed to about 3 inches above the height of the side walls. The back wall would therefore be mounted about 2 wall thicknesses above the first side wall to fold in so that the back wall will rest horizontally on the second side wall to fold down. The back side will have small side frame about 0.75 of an inch wide and 1 inch high attached flush with the edge and on the underside. This small side frame is used to attach the left and right sides to the back side roof line when the camper is erected.

The back side will be about 5 inches short of 8 feet so that when it is folded down it can end before the mounting of the front/top side. The hinge across the back side wall should be located about 39 inches from the bottom of the wall. That way, when it is erected, it will line up with the height of the side walls allowing for the differing heights in mounting. That would leave about 52 inches above the hinge to form the back half of the roof. See drawing 1. The top half of the door is also cut into the base of the back side. Because the back side is mounted 3 inches above the fixed side walls to allow for folding the left and right sides down, there will be a 3 inch gap between the bottom door and the top door. An additional 3 inch tall piece is added to the top of the door in the base after the unit is erected to fill this gap and removed before the unit is folded down.

The front/top side will be mounted about 4.5 inches above the fixed side wall which represents about 3 wall thicknesses. See drawing 5. The 4.5 inch mounting piece should be no wider than the width of the back wall because the side frame of the front/top will need to clear this piece when it is folded down. The inside width of the front/top should be greater than the width of the back side by about an eighth of an inch to allow for tolerances when folding the unit down. If desired, a wind board can be mounted to the front of the 4.5 inch piece to extend past the sides and top of the folded front/top side to divert wind and rain when traveling at high speed.

The front/top side is hinged across it's width about 37.5 inches from the bottom. This leaves enough vertical height along with the 4.5 inch mounting piece so that the left and right sides will match up with the vertical and horizontal sides when in the erected position.

The side frame on the front/top side will be about 5.5 to 6 inches tall so that it will fully encapsulate the folded sides and rest on the top rail of the fixed walls. The side frame is angled at the hinge joint in the front/top such that when erected the angles of the side frame fit together and support the weight of the roof and the hinge joint itself. See drawing 6. Also, notice there is an additional piece of side frame attached to the base of the front/top wall. This additional piece of side frame acts to stabilize and align the joint when erecting the front/top side. It also covers the gap caused by cutting an angle into the side frame when the front/top is folded down. Additionally, there is an eye bolt attached to the additional piece of side frame that helps during the process of erecting the structure. A handle is added to the back of the front top side to help in starting to erect the camper, see below.

To erect the structure from the folded down position requires 4 prop sticks and 1 other board. First, standing on the rear bumper of the truck or the back of the truck bed, the back of the front/top side is lifted using the mounted handle. A board is inserted under the side frame of the front/top side and above the folded back side. Next the board is moved forward under the hinge in the front/top side to start the bending hinge action. The prop sticks are then inserted into the eye bolts on the side frame and used to push the vertical wall towards the front of the truck. During this pushing process, the angles cut into the side frames will come to rest on each other and the horizontal section of the roof will be propped up by the prop sticks. The ends of the prop sticks are positioned behind some stop blocks fixed to the outside of the top rail on the fixed wall. The front/top side now stands erect all by itself by means of the prop sticks. The back wall can be raised by lifting at the hinge and then manually pushing it to the rear. The other 2 prop sticks can be used to temporarily hold up the roof section of the back side. At this point the two roof sections intersect each other with the back side roof fitting below and into the front/top side frame. Next by using ropes that are permanently attached to the middle apex of the left and right sides, the sides can be lifted to support the roof panels. It helps to have two people erecting the unit as one can work on each side to lift and position the sides and the prop sticks. Once the sides of the unit are erected, 4 or 5 screws are used along the roof line inside to screw the top of the left and right sides to the side frame of the roof panels. At this point the camper is fully erected and has good structural strength. See drawing 1.

1. The folding sides of this hard sided pop-up camper fold down to about 6 inches in height and rest on top of a short wall mounted to sides of the pickup truck bed making an efficient use of space so that the folded unit is short enough to allow the truck to fit into a garage and travel with minimum wind resistance.

2. This hard sided pop-up camper can be folded down and erected manually without the use of winches or cables.

3. When this hard sided pop-up camper is erected, there is enough vertical space within the unit for a 6 foot tall person to stand upright.
